(19) United States
(12) Patent Application Publication
(10) Pub. No.: US 2007/0268510 A1
(43) Pub. Date: Nov. 22, 2007

(54) Service dialog system supporting user reporting of printing errors

(76) Inventors: Dilinur Wushour, Antioch, CA (US); Emilia D. Baranda, Concord, CA (US)

Correspondence Address: Kyocera Technology Development;Intellectual Property Administration, Suite 400, 1855 Gateway Blvd., Concord, CA, 94520, US

(21) Appl. No.: 11/437,535

(22) Filed: May 19, 2006

(51) Int. Cl. G06K 15/00

(52) U.S. Cl. 358/1.14; 358/1.16

(57) ABSTRACT

A method for notifying a printing error, comprising: providing a GUI for a user to store printer settings into a temporary file; creating an error report comprising the temporary file; specifying a method of sending the error report; and sending the error report to a printer manufacturer. Users often have trouble reporting a printing problem to a manufacturer, because an average user finds it difficult to include the necessary description of the conditions and circumstances that gave rise to the problem. The service dialog supports and assists user reporting of printing errors. The methods also include aiding engineer diagnosis by including information on OS platform, service packs, applications, driver versions, device settings, driver property settings, etc.; detecting errors; inclusion of print stream and application source file; previewing report; specifying urgency and destination choice; specialized wizard GUI with itemized prompts; and voice mail to a central telephone number with serial identification code.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to printers, and more particularly to supporting and assisting user reporting of printing errors.

### BACKGROUND OF THE INVENTION

When there is a printing problem or issue with a printer that needs to be reported to a printer manufacturer, it is often difficult for an average user to include a complete description of the conditions, circumstances, environments, and settings that gave rise to the printing problem. Providing a complete description is difficult for an average user because it involves inclusion of technical information, like OS platform, service packs, applications, driver versions, driver property settings, etc. An incomplete description impedes timely analysis and diagnosis of the problem by the engineers. Existing systems have not adequately addressed these perceived needs and concerns, and the present invention arose out of the above concerns associated with providing better methods for supporting and assisting user reporting of printing errors.

### SUMMARY OF THE INVENTION

Methods, computer program products, computing and printing systems for supporting and assisting user reporting of printing errors are described. Reporting a printing issue by including information from the printer driver is a time consuming process for an end user since it requires the user to provide some technical information, like OS platform, service packs, applications, driver versions, and driver property settings, etc. It is often difficult for engineers and developers to reproduce an issue according to an error report because of limited information that a user usually can provide. Service Dialog feature of the present invention aims to provide a bridge between driver development (technical support) and the end user. It will create detailed information about user OS platform, application, and driver settings; and put them into the printable data or a text file that let driver development easily understand the issue, and this will shorten the fixing cycle. It will also provide a URL link to help user to contact with technical support or local service support without involving any third party. The Service Dialog feature of the present invention aims to link users to local technical/service support or the driver development group in order to report and resolve a driver issue they have found.

In an embodiment of the present invention, the methods include embedding driver information (writing information into the data stream). Embedded information includes driver basic information like driver version, model information, PDL settings, etc; and driver advanced settings like printer settings and selected each standard feature settings into the printable data stream. This feature is useful when users find a driver issue and try to report it with current settings. With this feature selection, all required driver information would be embedded into the printable data and user can send it to technical support as an issue report.

In a further embodiment of the present invention, the methods include gathering information to be put into a text file. This information includes OS platform, service packs and application property settings in addition to other embedded driver information. A user can send this text file via email along with the issue report; or Fax it to corresponding party.

In a further embodiment of the present invention, the methods include providing a URL link to a local service support. Local service support may provide some technical information like Frequently Asked Questions or an email address for this issue report. Each local service support can collect some regular known issues in the driver and also provide their solving tips.

In a further embodiment of the present invention, the methods include automatically sending an email to a corresponded party or technical support with the attachment of two files that which are embedded printable data and text data. This means end user can directly contact with the driver technical support without involving a third party, which also shortens the reporting and fixing cycle and increases user satisfaction.

The invention will be more fully understood upon consideration of the detailed description below, taken together with the accompanying drawings.

### DESCRIPTION OF THE DRAWINGS

FIG. 1 is a simplified block diagram showing connection of a computing system to a printer, in accordance with a preferred embodiment of the present invention.

FIG. 2 is a flowchart showing the overall processing for user reporting of printing error, in accordance with a preferred embodiment of the present invention.

FIG. 3 is a sample GUI of service dialog system displaying printing preference settings for confirmation, in accordance with a preferred embodiment of the present invention.

FIG. 4 is a flowchart showing the processing steps for specifying the methods of creating and sending the error report, in accordance with a preferred embodiment of the present invention.

FIG. 5 is a flowchart showing the processing steps for creating a voice mail to be included in the error report, in accordance with a preferred embodiment of the present invention.

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

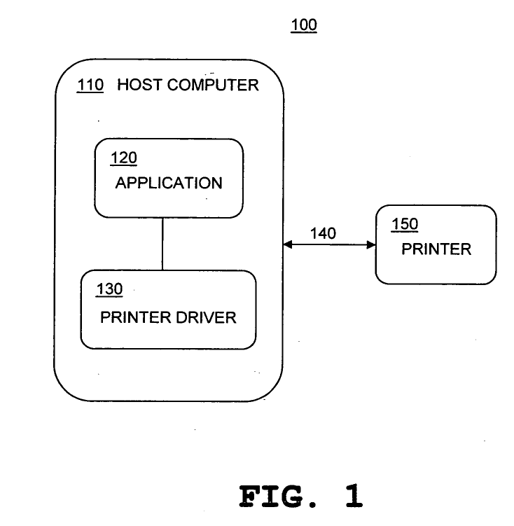

FIG. 1 is a simplified block diagram showing connection of a computing system to a printer, in accordance with a preferred embodiment of the present invention. FIG. 1 shows a general printing system setup 100 that includes a host computer 110 and a printer 150. Here, the printer 150 may be any device that can act as a printer, e.g. an inkjet printer, a laser printer, a photo printer, or an MFP (Multifunction Peripheral or Multi-Functional Peripheral) that may incorporate additional functions such as faxing, facsimile transmission, scanning, and copying.

The host computer 110 includes an application 120 and a printer driver 130. The application 120 refers to any computer program that is capable of issuing any type of request, either directly or indirectly, to print information. Examples of an application include, but are not limited to, commonly used programs such as word processors, spreadsheets, browsers and imaging programs. Since the invention is not platform or machine specific, other examples of application 120 include any program written for any device, including personal computers, network appliance, handheld computer, personal digital assistant, handheld or multimedia devices that is capable of printing.

The printer driver 130 is a software interfacing with the application 120 and the printer 150. Printer drivers are generally known. They enable a processor, such as a personal computer, to configure an output data from an application that will be recognized and acted upon by a connected printer. The output data stream implements necessary synchronizing actions required to enable interaction between the processor and the connected printer. For a processor, such as a personal computer, to operate correctly, it requires an operating system such as DOS (Disk Operating System) Windows, Unix, Linux, Palm OS, or Apple OS.

A printer I/O (Input/Output) interface connection 140 is provided and permits host computer 110 to communicate with a printer 150. Printer 150 is configured to receive print commands from the host computer and, responsive thereto, render a printed media. Various exemplary printers include laser printers that are sold by the assignee of this invention. The connection 140 from the host computer 110 to the printer 150 may be a traditional printer cable through a parallel interface connection or any other method of connecting a computer to a printer used in the art, e.g., a serial interface connection, a remote network connection, a wireless connection, or an infrared connection. The varieties of processors, printing systems, and connection between them are well known.

The present invention is suited for printer drivers, and it is also suited for other device drivers. The above explanations regarding FIG. 1 used a printer driver rather than a general device driver for concreteness of the explanations, but they also apply to other device drivers. Similarly, the following descriptions of the preferred embodiments generally use examples pertaining to printer driver, but they are to be understood as similarly applicable to other kinds of device drivers.

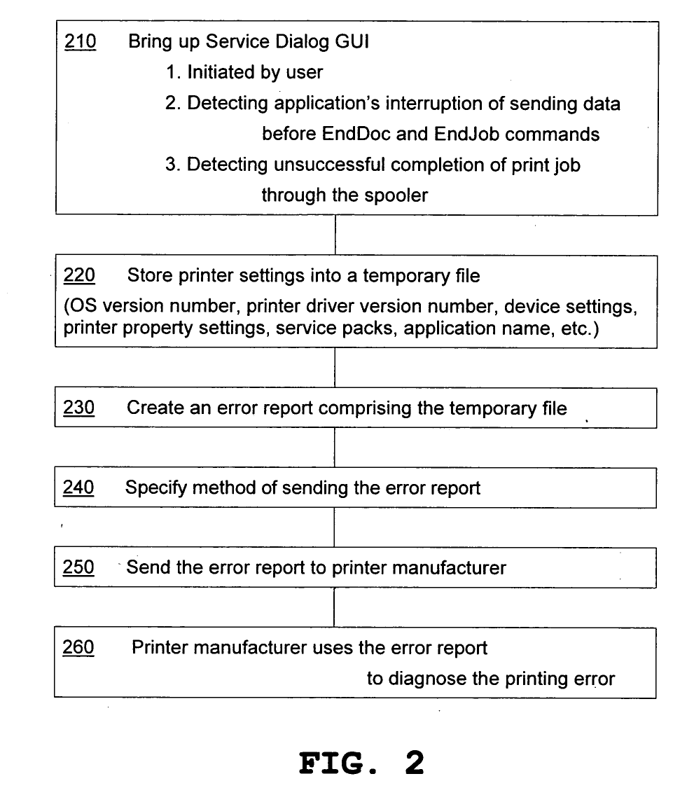

FIG. 2 is a flowchart showing the overall processing for user reporting of printing error, in accordance With a preferred embodiment of the present invention. The Service Dialog of the present invention will be a standard feature of a printer driver, and it is typically located inside of the “About” tab. It is typically integrated into driver core and each PDL portion.

In step 210, the Service Dialog GUI of the dialog is brought up on the screen. There are three ways that this GUI can be brought up.

First, it can be initiated by the user. When a user finds an issue during a printing process and would like to get a service from a corresponding party, the user would just need to click a “Service . . . ” button located somewhere in a printing menu. The Service Dialog window will be pop-up as shown in a later figure. In many situations, a printing error is such that a printing completes normally from the standpoint of the application and the printer driver, but there is an anomaly in the actual printout. In this type of situation, only the user can detect an anomaly in the resulting printout and initiate reporting of the error.

Second, it can be initiated by detecting an application's interruption of sending data before issuing EndDoc and EndJob commands. When a user prints a document from an application or from a file manager (e.g., Windows Explorer), the application and the printer driver are constantly exchanging information. The application sends some print data to the printer driver, and the printer drivers sends back an acknowledgement, requesting more data to be sent, and so on. If an application or a file manager crashes, typically a dialog menu comes up notifying the user that the program stopped responding. When this situation occurs, it can be detected by the printer driver because the printer driver can notice that the application has stopped sending data before issuing the EndDoc and EndJob commands. Upon noticing this situation, the Service Dialog GUI can be brought up on the screen.

Third, it can be initiated by detecting unsuccessful completion of print job through the spooler or port monitor. For example, when a printer functions abnormally before a printing is complete, a print error may be indicated in the list showing the status of Printers and FAXes, the list that usually shows whether each printer is busy, the number of print jobs on the queue for each printer, etc. If a printer job is not completed successfully or normally, that is, if a print job is detected to be on hold or waiting in an anomalous manner, then depending on the setting of the Service Dialog GUI (which may set, say, how long to wait before bring up the menu), the Service Dialog GUI can be brought up on the screen.

There are typically four kinds of options available for user selection.

The first option is a Technical Support URL link. When user clicks this button, the Internet Explorer will be loaded automatically and linked to the local service support website or printer manufacturer technical support website. These websites can offer a list of FAQs and answers to regular known issues in specific versions of the driver and their fixing tips. Or they can offer different contact information according to the nature of the issue user experienced.

The second option is a Products and Supplies URL link. When a user clicks on this button, the Internet Explorer will link the user to company's Product and Supplies website. This website may include the information about printer manufacturer's printer/copier products, cartridges and other related supplies.

The third option is a Feedback link. This link opens an email message box and the receiving address will be filled automatically. The user can attach PRN or TXT files created through the next selection of Service Dialog feature into this email.

The fourth option is a Support Information dialog. This option can be selected using a hot key (e.g., Ctrl-Alt-F1). All information that will be included in the data stream or an export text file will be listed with different category.

In step 220, printer settings are stored into a temporary file. The relevant settings may include OS version number, printer driver version number, device settings, printer property settings, service packs, application name, etc.

In step 230, an error report is created that includes the temporary file. In step 240, methods of sending the error report are specified. In step 250, the error report is sent to the printer manufacturer. In step 260, the engineers at the printer manufacturer uses the error report to diagnose the printing error. More details of these steps are described later.

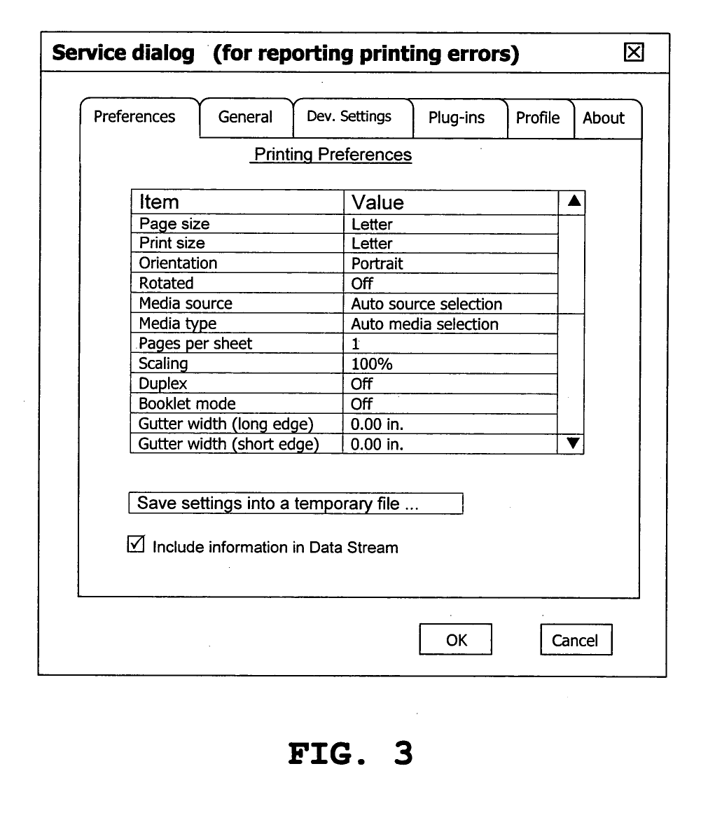

FIG. 3 is a sample GUI of service dialog system displaying printing preference settings for confirmation, in accordance with a preferred embodiment of the present invention. The various tabs show groups of settings that are included into the error report. The tabs shown in FIG. 3 are Preferences, General, Device Settings, Plug-ins, Profile, and About. The following driver information will be embedded into user created PRN data using PJL commands. The information also can be included in a user created text file and attached to an email report.

The first tab is the Preferences tab for Printing Preferences. Most commonly used printing preferences information will be listed in this tab. The list includes, but is not limited to, the following information: Page size (letter, A4, . . . ), Print size (Same as page size, letter, A4, . . . ), Page Orientation (portrait/landscape), Page rotated/not rotated, Media source (Auto source selection or . . . ), Media type (Auto media selection or . . . ), Pages per sheet (1, 2, 4, etc), Scaling (100%, 120%, 80% . . . ), Duplex ON/OFF, Booklet mode ON/OFF, Gutter width long edge (0.20˜1.00 in.), Gutter width short edge (0.20˜1.00 in.), Reduce image to fit ON/OFF, Download TTF as Outline is ON/OFF, Download TTF as Bitmap is ON/OFF, Disable Device Font is ON/OFF, Print Text as Black is ON/OFF, Reverse Image is ON/OFF, Mirror Printing is ON/OFF, Output copies, Collate is ON/OFF, Reverse Order printing is ON/OFF, etc.

The General tab lists user platform information and driver basics. The list includes, but is not limited to, the following information: OS version, Local Driver, Service Pack, Physical Memory, Regional Information (locale), IE Version, Driver Version, Application and Version, Printer Model, User Mode Driver, Server Driver, Kernel Mode Driver, Client Driver, Printing Port, etc.

Device Settings tab lists major device settings of the printer driver. The list includes, but is not limited to, the following information: Page Description Language, Hard Disk, GDI Mode, Ram Disk, Resolution, Job Accounting, Side Feeder, Management Code, Multi Finisher, etc.

The Plug-ins tab lists printer driver plug-in features and indicates their availability. The list includes, but is not limited to, the following information: Watermark, Prologue/Epilogue, Poster Mode, Output to TIFF, Overlay, Macro Generator, etc.

The “Export” button is shown in FIG. 3 with “Save settings into a temporary file . . . ” text label. The button is provided to save these support information into a text file. User needs to locate the text file in a specific location in case they will email it to the driver development as an issue report. This text file is very useful for driver development to further investigate the issue.

Checkbox in FIG. 3 with “Include information in Data Stream” text label. This checkbox (Include Information in Data Stream) is provided to embed the support information into the printable data stream. This is helpful when user reports issue with an attached printable data which includes support information. Driver technical support will investigate the issue easily using dumped data stream.

In an embodiment of the present invention, the Service Dialog feature of the present invention will be integrated into the printer driver as a standard Feature Set. This feature will be supported by different Windows OSs that are supported by the printer driver. This feature will be implemented inside of each PDL and driver core portion. It will be independent from Render model of the printer driver. The Service Dialog feature will collect information about other features and their specific settings.

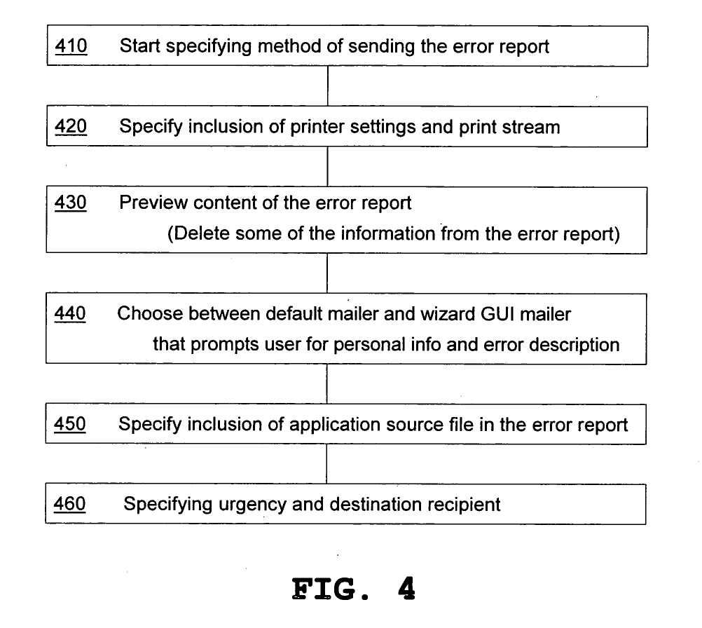

FIG. 4 is a flowchart showing the processing steps for specifying the methods of creating and sending the error report, in accordance with a preferred embodiment of the present invention.

In step 410, the process of specifying method of sending the error report is started. After the Service Dialog of the present invention is brought up, the user specifies the methods of sending the error report by following the prompts of the wizard-like interface and by changing the settings of the checkboxes, etc. of the various tabs of the menu.

In step 420, inclusion of printer settings and print stream is specified. When using a regular or default email system, specifying inclusion of material in addition to the text of the email is done by specifying attachments to the email. The “Export” or “Save settings into a temporary file . . . ” button is provided to save these support information into a temporary, text file. The user needs to locate the text file in a specific location in case they will email it to the driver development as an issue report. The checkbox with the “Include information in Data Stream” text label is used to embed the support information into the printable data stream. This is helpful when user reports issue with an attached printable data which includes support information. Driver technical support will investigate the issue easily using dumped data stream.

In step 430, the user previews the content of the error report before sending the error report, by going to the different tabs within the menu. Thus, the user can confirm the content of the system information being included in the report, and as the result can feel safe that no confidential or private system information is being sent to an outside party. In an embodiment of the invention, if the user wishes to exclude certain information or setting from the error report, the user can do this by right-clicking on the row of item-value pair that corresponds to the item to be deleted.

In step 440, the user chooses between using the default mailer (email system) and the specialized wizard GUI mailer that prompts user for personal info and error description. The default emailer may be more familiar and easier to use, but the specialized emailer may provide additional functionalities, such as those regarding voice mail, as described below.

In step 450, the user specifies inclusion of application source file in the error report. When a print stream is included in the error report, the information of the source file should be reconstructed from the print stream. However, including the actual application source file may provide additional information and clues in analyzing the error.

In step 460, the user specifies urgency and destination recipient of the error report. The urgency rating provided by the user may help the engineers assess the importance of the quickly resolving the issue. Furthermore, if the user has some understanding of the nature of the error or its causes, the user may provide extra assistance by choosing and directing the error report to a specialized email recipient address instead of the most general recipient address.

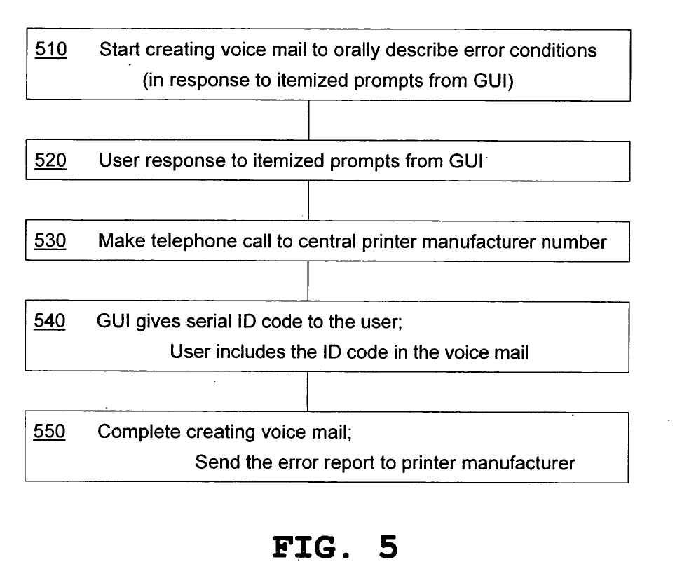

FIG. 5 is a flowchart showing the processing steps for creating a voice mail to be included in the error report, in accordance with a preferred embodiment of the present invention.

In step 510, the user starts creating voice mail to orally describe error conditions. In an embodiment of the invention, this step is started in response to itemized prompts from the wizard GUI, which contains functionalities for directly including the voice mail report into the error report to be sent to the printer manufacturer. In another embodiment of the invention, the voice mail report is made through a telephone call to a toll-free number of the printer manufacturer.

In step 520, user response to itemized prompts from GUI. The prompts may be textual and/or audible, and prompt for information about personal identification information of the user, which may be supplemented by the IP address of the user that is automatically detected, and error descriptions. The error descriptions include the conditions and circumstances that gave rise to the observed or perceived error, such as the name of the application used, the subsystem or feature of the application that was used at the time of the error, the particular tasks or keystrokes that resulted in the error, and other information that may be helpful to reproduce and diagnose the error.

In step 530, the user makes a telephone call to central printer manufacturer number. Even when a wizard GUI is used, which contains functionalities for directly including the voice mail report into the error report to be sent to the printer manufacturer, this step may ensure that voice mail is delivered to the printer manufacturer.

In step 540, GUI gives serial ID code to the user; and the user includes the ID code in the voice mail. This is especially important when a telephone call to central printer manufacturer number is the only means of delivering the voice mail report. The ID code ensures that voice mail is properly matched up with the rest of the error report. Without such means to connect the voice mail report, the voice mail report may get lost, wherein the engineers of the printer manufacturer have no way of tracing or locating the origin of the voice mail report.

In step 550, the user confirms the content of the error report, including the content of the voice mail. When the user is satisfied with the content of the error report, the user completes creation of the voice mail, and sends the error report to printer manufacturer.

Although this invention has been largely described using terminology pertaining to printer drivers, one skilled in this art could see how the disclosed methods can be used with other device drivers. The foregoing descriptions used printer drivers rather than general device drivers for concreteness of the explanations, but they also apply to other device drivers. Similarly, the foregoing descriptions of the preferred embodiments generally use examples pertaining to printer driver settings, but they are to be understood as similarly applicable to other kinds of device drivers.

Although this invention has been largely described using Windows terminology, one skilled in this art could see how the disclosed methods can be used with other operating systems, such as DOS, Unix, Linux, Palm OS, or Apple OS, and in a variety of devices, including personal computers, network appliance, handheld computer, personal digital assistant, handheld and multimedia devices, etc. One skilled in this art could also see how the user could be provided with more choices, or how the invention could be automated to make one or more of the steps in the methods of the invention invisible to the end user.

While this invention has been described in conjunction with its specific embodiments, it is evident that many alternatives, modifications and variations will be apparent to those skilled in the art. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A method for notifying a printing error, comprising: providing a GUI for a user to store at least one printer setting into a temporary file; creating an error report comprising the temporary file; specifying a method of sending the error report; and sending the error report to a printer manufacturer.

2. The method of claim 1, wherein the at least one printer setting comprises operating system version number, printer driver version number, printer model device settings, printer property selections, service packs, and application name, which are automatically collected into the temporary file to assist diagnosis of a printing error.

3. The method of claim 1, wherein the GUI is presented to the user when a printer driver detects a printing error by detecting an application's interruption of sending data before and EndDoc and EndJob commands and by detecting unsuccessful completion of a print job through the spooler.

4. The method of claim 1, wherein the specifying of a method of sending the error report comprises specifying inclusion of print stream in the error report; and previewing the content of the error report, and optionally deleting a subset of the at least one printer setting from the temporary file.

5. The method of claim 1, wherein the specifying of a method of sending the error report comprises specifying inclusion of application source file in the error report; and specifying urgency and a choice from at least one destination recipient.

6. The method of claim 1, wherein the specifying of a method of sending the error report comprises specifying a choice between a default email system and a specialized wizard GUI that prompts the user for personal information and at least one written error description.

7. The method of claim 1, wherein the error report comprises a voice mail of the user orally describing at least one error condition and circumstances, in responses to at least one itemized prompt given to the user by the GUI.

8. The method of claim 7, wherein the voice mail is a telephone call to a central telephone number of the printer manufacturer, and the voice mail comprising a serial identification code given to the user by the GUI, which the user includes in the user's voice mail.

9. A computer program product for notifying a printing error, comprising machine-readable code for causing a machine to perform the method steps of: providing a GUI for a user to store at least one printer setting into a temporary file; creating an error report comprising the temporary file; specifying a method of sending the error report; and sending the error report to a printer manufacturer.

10. The computer program product of claim 9, wherein the at least one printer setting comprises operating system version number, printer driver version number, printer model device settings, printer property selections, service packs, and application name, which are automatically collected into the temporary file to assist diagnosis of a printing error.

11. The computer program product of claim 9, wherein the GUI is presented to the user when a printer driver detects a printing error by detecting an application's interruption of sending data before and EndDoc and EndJob commands and by detecting unsuccessful completion of a print job through the spooler.

12. The computer program product of claim 9, wherein the specifying of a method of sending the error report comprises specifying inclusion of print stream in the error report; and previewing the content of the error report, and optionally deleting a subset of the at least one printer setting from the temporary file.

13. The computer program product of claim 9, wherein the specifying of a method of sending the error report comprises specifying inclusion of application source file in the error report; specifying urgency and a choice from at least one destination recipient; specifying a choice between a default email system and a specialized wizard GUI that prompts the user for personal information and at least one written error description.

14. The computer program product of claim 9, wherein the error report comprises a voice mail of the user orally describing at least one error condition and circumstances, in responses to at least one itemized prompt given to the user by the GUI, and wherein the voice mail is a telephone call to a central telephone number of the printer manufacturer, and the voice mail comprising a serial identification code given to the user by the GUI, which the user includes in the user's voice mail.

15. A computing system for notifying a printing error comprising a print engine, comprising: providing a GUI for a user to store at least one printer setting into a temporary file; creating an error report comprising the temporary file; specifying a method of sending the error report; and sending the error report to a printer manufacturer.

16. The computing system of claim 15, wherein the at least one printer setting comprises operating system version number, printer driver version number, printer model device settings, printer property selections, service packs, and application name, which are automatically collected into the temporary file to assist diagnosis of a printing error.

17. The computing system of claim 15, wherein the GUI is presented to the user when a printer driver detects a printing error by detecting an application's interruption of sending data before and EndDoc and EndJob commands and by detecting unsuccessful completion of a print job through the spooler.

18. The computing system of claim 15, wherein the specifying of a method of sending the error report comprises specifying inclusion of print stream in the error report; and previewing the content of the error report, and optionally deleting a subset of the at least one printer setting from the temporary file.

19. The computing system of claim 15, wherein the specifying of a method of sending the error report comprises specifying inclusion of application source file in the error report; specifying urgency and a choice from at least one destination recipient; specifying a choice between a default email system and a specialized wizard GUI that prompts the user for personal information and at least one written error description.

20. The computing system of claim 15, wherein the error report comprises a voice mail of the user orally describing at least one error condition and circumstances, in responses to at least one itemized prompt given to the user by the GUI, and wherein the voice mail is a telephone call to a central telephone number of the printer manufacturer, and the voice mail comprising a serial identification code given to the user by the GUI, which the user includes in the user's voice mail.
